(19) United States
(12) Patent Application Publication
(10) Pub. No.: US 2025/0015937 A1
(43) Pub. Date: Jan. 9, 2025

(54) METHOD, APPARATUS AND COMPUTER PROGRAM

(71) Applicant: Nokia Technologies Oy, Espoo (FI)

(72) Inventors: Zexian LI, Espoo (FI); Klaus Ingemann PEDERSEN, Aalborg (DK); Stefano PARIS, Vanves (FR); Benoist Pierre SEBIRE, Tokyo (JP)

(21) Appl. No.: 18/703,012

(22) PCT Filed: Nov. 3, 2021
(86) PCT No.: PCT/EP2021/080440

§ 371 Date: Apr. 19, 2024

(51) Int. Cl. H04L 1/1867; H04L 1/1607

(52) U.S. Cl. CPC H04L 1/1887; H04L 1/1642; H04L 1/1896

(57) ABSTRACT

A first apparatus including means for: sending, to a second apparatus, one or more transport blocks corresponding to a first packet of a sequence of packets, the sequence including the first packet and one or more subsequent packets, wherein decoding of the one of more subsequent packets is dependent on successfully decoding the first packet; determining that at least one of the one or more transport blocks corresponding to the first packet have not been successfully received by the second apparatus; and temporarily deactivating resources configured for sending the sequence of packets based on the determining.

### FIELD

The present application relates to a method, apparatus, and computer program and in particular but not exclusively to temporarily deactivating resources configured for sending a sequence of packets.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication apparatus. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication apparatus or terminal. A communication apparatus of a user may be referred to as user equipment (UE) or user apparatus. A communication apparatus is provided with an appropriate signal receiving and transmitting apparatus for enabling communications, for example enabling access to a communication network or communications directly with other users. The communication apparatus may access a carrier provided by a station, for example a base station of a cell, and transmit and/or receive communications on the carrier.

The communication system and associated apparatus typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to an aspect, there is provided an apparatus comprising means for: A first apparatus comprising means for: sending, to a second apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the second apparatus; and temporarily deactivating resources configured for sending the sequence of packets based on the determining.

Determining that the at least one of the one or more transport blocks corresponding to the first packet have not been successfully received by the second apparatus may comprise: receiving, from the second apparatus, an indication that the at least one of the one or more transport blocks corresponding to the first packet have not been successfully received by the second apparatus.

Temporarily deactivating the resources allocated for transmission of the sequence of packets may comprise: sending, to the second apparatus, an indication for temporarily deactivating the resources allocated for reception of the sequence of packets at the second apparatus.

Temporarily deactivating the resources allocated for transmission of the sequence of packets may comprise: cancelling transmission of any transport blocks associated with the first packet which have not been transmitted; and/or cancelling transmission of any transport blocks associated with the one or more subsequent packets; and/or cancelling transmission of any one or more higher layer packet data packets associated with the one or more subsequent packets.

The means may be for sending, to the second apparatus: a traffic pattern comprising information identifying one or more time intervals during which the first apparatus will send the sequence of packets; and/or information identifying a time period and/or a number of time intervals relating to temporarily deactivating the resources allocated for reception of the sequence of packets at the second apparatus.

A duration of the deactivation may be based on: the one or more time intervals during which the first apparatus will send the one or more subsequent packets in the sequence; and/or the information identifying the time period and/or the number of time intervals.

The first apparatus may be a network node, and the second apparatus may be a user equipment.

The means may be for: sending, to a third apparatus, configuration information for delivering the sequence of packets to the second apparatus via the first apparatus and the third apparatus, wherein the first apparatus is a hosting node and the third apparatus is an assisting node; and in response to determining that the at least one of the one or more transport blocks corresponding to the first packet have not been received by the second apparatus, sending, to the third apparatus, an indication for temporarily deactivating resources allocated for transmission of the sequence of packets at the third apparatus.

Determining that at least one of the one or more transport blocks corresponding to the first packet have not been received by the second apparatus may comprise: receiving, from the third apparatus, an indication that one or more transport blocks corresponding to the first packet sent via the third apparatus have not been received by the second apparatus.

The means may be for: determining to reactivate the resources allocated for transmission of the sequence of packets; sending, to the third apparatus, an indication to reactivate the resources allocated for transmission of the sequence of packets; and sending, to the second apparatus, a command to reactivate the resources allocated for reception of the sequence of packets at the second apparatus.

The means may be for: receiving, from a third apparatus, configuration information for delivering the sequence of packets to the second apparatus via the first apparatus and the third apparatus, wherein the first apparatus is an assisting node and the third apparatus is a hosting node, wherein the sending is performed based on the configuration information.

Determining that at least one of the one or more transport blocks corresponding to the first packet have not been received by the second apparatus may comprise: determining that the at least one of the one or more transport blocks corresponding to the first packet sent by the first apparatus have not been received by the second apparatus; and sending, to the third apparatus, an indication that the at least one of the one or more transport blocks corresponding to the first packet sent by the first apparatus have not been received by the second apparatus; or receiving, from the third apparatus, an indication that at least one of the one or more transport blocks corresponding to the first packet sent by the third apparatus have not been received by the second apparatus.

The means may be for: receiving, from the third apparatus, an indication to reactivate the resources allocated for transmission of the sequence of packets; and sending, to the second apparatus, a command to reactivate the resources allocated for transmission of the sequence of packets.

According to an aspect, there is provided a second apparatus comprising means for: receiving, from a first apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the second apparatus; and temporarily stopping receiving one or more transport blocks of the sequence of packets using resources configured for reception of the sequence of packets based on the determining.

The means may be for: sending, to the first apparatus, an indication that the at least one of the one or more transport blocks corresponding to the first packet have not been received by the second apparatus.

The means may be for: receiving, from the first apparatus, an indication for temporarily deactivating resources allocated for reception of the sequence of packets, wherein the temporarily stopping is performed responsive to receiving the indication.

The means may be for receiving, from the first apparatus: a traffic pattern comprising information identifying one or more time intervals during which the first apparatus will send the sequence of packets; and/or information identifying a time period and/or a number of time intervals relating to temporarily deactivating the resources allocated for reception of the sequence of packets at the second apparatus.

A duration of the deactivation may be based on: the one or more time intervals during which the first apparatus will send the one or more subsequent packets in the sequence; and/or the information identifying the time period and/or the number of time intervals.

The means may be for: stopping decoding of at least one received transport block corresponding to the first packet in response to temporarily deactivating the resources.

The first apparatus may be a network node, and the second apparatus may be a user equipment.

According to an aspect, there is provided a first apparatus comprising means for: receiving, from a second apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the first apparatus; and temporarily deactivating resources configured for receiving the sequence of packets based on the determining.

Determining that at least one of the one or more transport blocks corresponding to the first packet have not been received by the second apparatus may comprise: determining that at least one of the one or more transport blocks corresponding to the first packet have not been received by the first apparatus; responsive to the determining, sending, to the second apparatus, a retransmission grant for retransmitting the at least one of the one or more transport blocks corresponding to the first packet; receiving, from the second apparatus, retransmitted one or more transport blocks corresponding to the first packet; determining that at least one of the retransmitted one or more transport blocks corresponding to the first packet have not been received by the first apparatus; and temporarily deactivating the resources in response to determining that the at least one of the retransmitted one or more transport blocks corresponding to the first packet have not been received by the first apparatus.

Temporarily deactivating the resources may comprise: sending, to the second apparatus, an indication to temporarily deactivating the resources allocated for sending the sequence of packets.

The means may be for: stopping decoding of at least one received transport block corresponding to the first in response to temporarily deactivating the resources.

The means may be for sending, to the second apparatus: a traffic pattern comprising information identifying one or more time intervals during which the second apparatus will send the sequence of packets; and/or information identifying a time period and/or a number of time intervals relating to temporarily deactivating the resources allocated for sending of the sequence of packets.

A duration of the deactivation may be based on: the one or more time intervals during which the second apparatus will send the one or more subsequent packets in the sequence; and/or the information identifying the time period and/or the number of time intervals.

The first apparatus may be a network node and the second apparatus may be a user equipment.

According to an aspect, there is provided a second apparatus comprising means for: sending, to a first apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the second apparatus; and temporarily stopping sending one or more transport blocks of the sequence of packets using resources configured for sending the sequence of packets based on the determining.

Determining that the at least one of the one or more transport blocks corresponding to the first packet have not been received by the first apparatus may comprise: receiving, from the first apparatus, an indication to temporarily deactivating the resources allocated for sending the sequence of packets, wherein the temporarily stopping is based on the received indication.

The means may be for: receiving, from the first apparatus, information indicating resources allocated for retransmission of one or more of the transport blocks of the first packet; and resending the one or more transport blocks corresponding to the first packet in response to receiving the information indicating the resources allocated for the retransmission.

The means may be for receiving, from the first apparatus: a traffic pattern comprising information identifying one or more time intervals during which the second apparatus will send the sequence of packets; and/or information identifying a time period and/or a number of time intervals relating to temporarily deactivating the resources allocated for sending of the sequence of packets.

A duration of the deactivation may be based on: the one or more time intervals during which the second apparatus will send the one or more subsequent packets in the sequence; and/or the information identifying the time period and/or the number of time intervals.

The first apparatus may be a user equipment, and the second apparatus may be a network node.

The sequence of packets may comprise a sequence of video frames comprising a first frame and one or more subsequent frames.

The first frame may comprise an intra-coded picture frame, and wherein the one or more subsequent frames may comprise at least one predicted picture frame and/or at least one bidirectional predicted picture frame.

Temporarily deactivating the resources allocated for transmission of the sequence of packets may comprise: modifying resources allocated for at least one of the one or more subsequent packets for retransmission of the at least one of the one or more transport blocks corresponding to the first packet that have not been received by the second apparatus; and temporarily deactivating the remaining resources allocated for sending the sequence of packets.

According to an aspect, there is provided a first apparatus comprising at least one processor and at least one memory including a computer program code, the at least one memory and computer program code configured to, with the at least one processor, cause the first apparatus at least to: send, to a second apparatus, one or more transport blocks corresponding to a first packet of a sequence of packets, the sequence comprising the first packet and one or more subsequent packets, wherein decoding of the one of more subsequent packets is dependent on successfully decoding the first packet; determine that at least one of the one or more transport blocks corresponding to the first packet have not been successfully received by the second apparatus; and temporarily deactivate resources configured for sending the sequence of packets based on the determining.

The at least one memory and at least one processor may be configured to cause the first apparatus to: receive, from the second apparatus, an indication that the at least one of the one or more transport blocks corresponding to the first packet have not been successfully received by the second apparatus.

The at least one memory and at least one processor may be configured to cause the first apparatus to: send, to the second apparatus, an indication for temporarily deactivating the resources allocated for reception of the sequence of packets at the second apparatus.

The at least one memory and at least one processor may be configured to cause the first apparatus to: cancel transmission of any transport blocks associated with the first packet which have not been transmitted; and/or cancel transmission of any transport blocks associated with the one or more subsequent packets; and/or cancel transmission of any one or more higher layer packet data packets associated with the one or more subsequent packets.

The at least one memory and at least one processor may be configured to cause the first apparatus to send, to the second apparatus: a traffic pattern comprising information identifying one or more time intervals during which the first apparatus will send the sequence of packets; and/or information identifying a time period and/or a number of time intervals relating to temporarily deactivating the resources allocated for reception of the sequence of packets at the second apparatus.

A duration of the deactivation may be based on: the one or more time intervals during which the first apparatus will send the one or more subsequent packets in the sequence; and/or the information identifying the time period and/or the number of time intervals.

The first apparatus may be a network node, and the second apparatus may be a user equipment.

The at least one memory and at least one processor may be configured to cause the first apparatus to: send, to a third apparatus, configuration information for delivering the sequence of packets to the second apparatus via the first apparatus and the third apparatus, wherein the first apparatus is a hosting node and the third apparatus is an assisting node; and in response to determining that the at least one of the one or more transport blocks corresponding to the first packet have not been received by the second apparatus, send, to the third apparatus, an indication for temporarily deactivating resources allocated for transmission of the sequence of packets at the third apparatus.

The at least one memory and at least one processor may be configured to cause the first apparatus to: receive, from the third apparatus, an indication that one or more transport blocks corresponding to the first packet sent via the third apparatus have not been received by the second apparatus.

The at least one memory and at least one processor may be configured to cause the first apparatus to: determine to reactivate the resources allocated for transmission of the sequence of packets; send, to the third apparatus, an indication to reactivate the resources allocated for transmission of the sequence of packets; and send, to the second apparatus, a command to reactivate the resources allocated for reception of the sequence of packets at the second apparatus.

The at least one memory and at least one processor may be configured to cause the first apparatus to: receive, from a third apparatus, configuration information for delivering the sequence of packets to the second apparatus via the first apparatus and the third apparatus, wherein the first apparatus is an assisting node and the third apparatus is a hosting node, wherein the sending is performed based on the configuration information.

The at least one memory and at least one processor may be configured to cause the first apparatus to: determine that the at least one of the one or more transport blocks corresponding to the first packet sent by the first apparatus have not been received by the second apparatus; and send, to the third apparatus, an indication that the at least one of the one or more transport blocks corresponding to the first packet sent by the first apparatus have not been received by the second apparatus; or receive, from the third apparatus, an indication that at least one of the one or more transport blocks corresponding to the first packet sent by the third apparatus have not been received by the second apparatus.

The at least one memory and at least one processor may be configured to cause the first apparatus to: receive, from the third apparatus, an indication to reactivate the resources allocated for transmission of the sequence of packets; and send, to the second apparatus, a command to reactivate the resources allocated for transmission of the sequence of packets.

According to an aspect, there is provided a second apparatus comprising at least one processor and at least one memory including a computer program code, the at least one memory and computer program code configured to, with the at least one processor, cause the second apparatus at least to: receive, from a first apparatus, one or more transport blocks corresponding to a first packet of a sequence of packets, the sequence comprising the first packet and one or more subsequent packets, wherein decoding of the one of more subsequent packets is dependent on successfully decoding the first packet; determine that at least one of the one or more transport blocks corresponding to the first packet have not been successfully received by the second apparatus; and temporarily stop receiving one or more transport blocks of the sequence of packets using resources configured for reception of the sequence of packets based on the determining.

The at least one memory and at least one processor may be configured to cause the second apparatus to: send, to the first apparatus, an indication that the at least one of the one or more transport blocks corresponding to the first packet have not been received by the second apparatus.

The at least one memory and at least one processor may be configured to cause the second apparatus to: receive, from the first apparatus, an indication for temporarily deactivating resources allocated for reception of the sequence of packets, wherein the temporarily stopping is performed responsive to receiving the indication.

The at least one memory and at least one processor may be configured to cause the second apparatus to receive, from the first apparatus: a traffic pattern comprising information identifying one or more time intervals during which the first apparatus will send the sequence of packets; and/or information identifying a time period and/or a number of time intervals relating to temporarily deactivating the resources allocated for reception of the sequence of packets at the second apparatus.

A duration of the deactivation may be based on: the one or more time intervals during which the first apparatus will send the one or more subsequent packets in the sequence; and/or the information identifying the time period and/or the number of time intervals.

The at least one memory and at least one processor may be configured to cause the second apparatus to: stop decoding of at least one received transport block corresponding to the first packet in response to temporarily deactivating the resources.

The first apparatus may be a network node, and the second apparatus may be a user equipment.

According to an aspect, there is provided a first apparatus comprising at least one processor and at least one memory including a computer program code, the at least one memory and computer program code configured to, with the at least one processor, cause the apparatus at least to: receive, from a second apparatus, one or more transport blocks corresponding to a first packet of a sequence of packets, the sequence comprising the first packet and one or more subsequent packets, wherein decoding of the one of more subsequent packets is dependent on successfully decoding the first packet; determine that at least one of the one or more transport blocks corresponding to the first packet have not been successfully received by the first apparatus; and temporarily deactivate resources configured for receiving the sequence of packets based on the determining.

The at least one memory and at least one processor may be configured to cause the first apparatus to: determine that at least one of the one or more transport blocks corresponding to the first packet have not been received by the first apparatus; responsive to the determining, send, to the second apparatus, a retransmission grant for retransmitting the at least one of the one or more transport blocks corresponding to the first packet; receive, from the second apparatus, retransmitted one or more transport blocks corresponding to the first packet; determine that at least one of the retransmitted one or more transport blocks corresponding to the first packet have not been received by the first apparatus; and temporarily deactivate the resources in response to determining that the at least one of the retransmitted one or more transport blocks corresponding to the first packet have not been received by the first apparatus.

The at least one memory and at least one processor may be configured to cause the first apparatus to: send, to the second apparatus, an indication to temporarily deactivating the resources allocated for sending the sequence of packets.

The at least one memory and at least one processor may be configured to cause the first apparatus to: stop decoding of at least one received transport block corresponding to the first in response to temporarily deactivating the resources.

The at least one memory and at least one processor may be configured to cause the first apparatus to send, to the second apparatus: a traffic pattern comprising information identifying one or more time intervals during which the second apparatus will send the sequence of packets; and/or information identifying a time period and/or a number of time intervals relating to temporarily deactivating the resources allocated for sending of the sequence of packets.

A duration of the deactivation may be based on: the one or more time intervals during which the second apparatus will send the one or more subsequent packets in the sequence; and/or the information identifying the time period and/or the number of time intervals.

The first apparatus may be a network node and the second apparatus may be a user equipment.

According to an aspect, there is provided a second apparatus comprising at least one processor and at least one memory including a computer program code, the at least one memory and computer program code configured to, with the at least one processor, cause the apparatus at least to: send, to a first apparatus, one or more transport blocks corresponding to a first packet of a sequence of packets, the sequence comprising the first packet and one or more subsequent packets, wherein decoding of the one of more subsequent packets is dependent on successfully decoding the first packet; determine that at least one of the one or more transport blocks corresponding to the first packet have not been successfully received by the second apparatus; and temporarily stop sending one or more transport blocks of the sequence of packets using resources configured for sending the sequence of packets based on the determining.

The at least one memory and at least one processor may be configured to cause the second apparatus to: receive, from the first apparatus, an indication to temporarily deactivating the resources allocated for sending the sequence of packets, wherein the temporarily stopping is based on the received indication.

The at least one memory and at least one processor may be configured to cause the second apparatus to: receive, from the first apparatus, information indicating resources allocated for retransmission of one or more of the transport blocks of the first packet; and resend the one or more transport blocks corresponding to the first packet in response to receiving the information indicating the resources allocated for the retransmission.

The at least one memory and at least one processor may be configured to cause the second apparatus to receive, from the first apparatus: a traffic pattern comprising information identifying one or more time intervals during which the second apparatus will send the sequence of packets; and/or information identifying a time period and/or a number of time intervals relating to temporarily deactivating the resources allocated for sending of the sequence of packets.

A duration of the deactivation may be based on: the one or more time intervals during which the second apparatus will send the one or more subsequent packets in the sequence; and/or the information identifying the time period and/or the number of time intervals.

The first apparatus may be a user equipment, and the second apparatus may be a network node.

The sequence of packets may comprise a sequence of video frames comprising a first frame and one or more subsequent frames.

The first frame may comprise an intra-coded picture frame, and wherein the one or more subsequent frames may comprise at least one predicted picture frame and/or at least one bidirectional predicted picture frame.

The at least one memory and at least one processor may be configured to cause the apparatus to: modify resources allocated for at least one of the one or more subsequent packets for retransmission of the at least one of the one or more transport blocks corresponding to the first packet that have not been received by the second apparatus; and temporarily deactivate the remaining resources allocated for sending the sequence of packets.

According to an aspect, there is provided a method comprising: sending, to a second apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the second apparatus; and temporarily deactivating resources configured for sending the sequence of packets based on the determining.

Determining that the at least one of the one or more transport blocks corresponding to the first packet have not been successfully received by the second apparatus may comprise: receiving, from the second apparatus, an indication that the at least one of the one or more transport blocks corresponding to the first packet have not been successfully received by the second apparatus.

Temporarily deactivating the resources allocated for transmission of the sequence of packets may comprise: sending, to the second apparatus, an indication for temporarily deactivating the resources allocated for reception of the sequence of packets at the second apparatus.

Temporarily deactivating the resources allocated for transmission of the sequence of packets may comprise: cancelling transmission of any transport blocks associated with the first packet which have not been transmitted; and/or cancelling transmission of any transport blocks associated with the one or more subsequent packets; and/or cancelling transmission of any one or more higher layer packet data packets associated with the one or more subsequent packets.

The method may comprise sending, to the second apparatus: a traffic pattern comprising information identifying one or more time intervals during which the first apparatus will send the sequence of packets; and/or information identifying a time period and/or a number of time intervals relating to temporarily deactivating the resources allocated for reception of the sequence of packets at the second apparatus.

A duration of the deactivation may be based on: the one or more time intervals during which the first apparatus will send the one or more subsequent packets in the sequence; and/or the information identifying the time period and/or the number of time intervals.

The first apparatus may be a network node, and the second apparatus may be a user equipment.

The method may comprise: sending, to a third apparatus, configuration information for delivering the sequence of packets to the second apparatus via the first apparatus and the third apparatus, wherein the first apparatus is a hosting node and the third apparatus is an assisting node; and in response to determining that the at least one of the one or more transport blocks corresponding to the first packet have not been received by the second apparatus, sending, to the third apparatus, an indication for temporarily deactivating resources allocated for transmission of the sequence of packets at the third apparatus.

Determining that at least one of the one or more transport blocks corresponding to the first packet have not been received by the second apparatus may comprise: receiving, from the third apparatus, an indication that one or more transport blocks corresponding to the first packet sent via the third apparatus have not been received by the second apparatus.

The method may comprise: determining to reactivate the resources allocated for transmission of the sequence of packets; sending, to the third apparatus, an indication to reactivate the resources allocated for transmission of the sequence of packets; and sending, to the second apparatus, a command to reactivate the resources allocated for reception of the sequence of packets at the second apparatus.

The method may comprise: receiving, from a third apparatus, configuration information for delivering the sequence of packets to the second apparatus via the first apparatus and the third apparatus, wherein the first apparatus is an assisting node and the third apparatus is a hosting node, wherein the sending is performed based on the configuration information.

Determining that at least one of the one or more transport blocks corresponding to the first packet have not been received by the second apparatus may comprise: determining that the at least one of the one or more transport blocks corresponding to the first packet sent by the first apparatus have not been received by the second apparatus; and sending, to the third apparatus, an indication that the at least one of the one or more transport blocks corresponding to the first packet sent by the first apparatus have not been received by the second apparatus; or receiving, from the third apparatus, an indication that at least one of the one or more transport blocks corresponding to the first packet sent by the third apparatus have not been received by the second apparatus.

The method may comprise: receiving, from the third apparatus, an indication to reactivate the resources allocated for transmission of the sequence of packets; and sending, to the second apparatus, a command to reactivate the resources allocated for transmission of the sequence of packets.

According to an aspect, there is provided a method comprising: receiving, from a first apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the second apparatus; and temporarily stopping receiving one or more transport blocks of the sequence of packets using resources configured for reception of the sequence of packets based on the determining.

The method may comprise: sending, to the first apparatus, an indication that the at least one of the one or more transport blocks corresponding to the first packet have not been received by the second apparatus.

The method may comprise: receiving, from the first apparatus, an indication for temporarily deactivating resources allocated for reception of the sequence of packets, wherein the temporarily stopping is performed responsive to receiving the indication.

The method may comprise receiving, from the first apparatus: a traffic pattern comprising information identifying one or more time intervals during which the first apparatus will send the sequence of packets; and/or information identifying a time period and/or a number of time intervals relating to temporarily deactivating the resources allocated for reception of the sequence of packets at the second apparatus.

A duration of the deactivation may be based on: the one or more time intervals during which the first apparatus will send the one or more subsequent packets in the sequence; and/or the information identifying the time period and/or the number of time intervals.

The method may comprise: stopping decoding of at least one received transport block corresponding to the first packet in response to temporarily deactivating the resources.

The first apparatus may be a network node, and the second apparatus may be a user equipment.

According to an aspect, there is provided a method comprising: receiving, from a second apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the first apparatus; and temporarily deactivating resources configured for receiving the sequence of packets based on the determining.

Determining that at least one of the one or more transport blocks corresponding to the first packet have not been received by the second apparatus may comprise: determining that at least one of the one or more transport blocks corresponding to the first packet have not been received by the first apparatus; responsive to the determining, sending, to the second apparatus, a retransmission grant for retransmitting the at least one of the one or more transport blocks corresponding to the first packet; receiving, from the second apparatus, retransmitted one or more transport blocks corresponding to the first packet; determining that at least one of the retransmitted one or more transport blocks corresponding to the first packet have not been received by the first apparatus; and temporarily deactivating the resources in response to determining that the at least one of the retransmitted one or more transport blocks corresponding to the first packet have not been received by the first apparatus.

Temporarily deactivating the resources may comprise: sending, to the second apparatus, an indication to temporarily deactivating the resources allocated for sending the sequence of packets.

The method may comprise: stopping decoding of at least one received transport block corresponding to the first in response to temporarily deactivating the resources.

The method may comprise sending, to the second apparatus: a traffic pattern comprising information identifying one or more time intervals during which the second apparatus will send the sequence of packets; and/or information identifying a time period and/or a number of time intervals relating to temporarily deactivating the resources allocated for sending of the sequence of packets.

A duration of the deactivation may be based on: the one or more time intervals during which the second apparatus will send the one or more subsequent packets in the sequence; and/or the information identifying the time period and/or the number of time intervals.

The first apparatus may be a network node and the second apparatus may be a user equipment.

According to an aspect, there is provided a method comprising: sending, to a first apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the second apparatus; and temporarily stopping sending one or more transport blocks of the sequence of packets using resources configured for sending the sequence of packets based on the determining.

Determining that the at least one of the one or more transport blocks corresponding to the first packet have not been received by the first apparatus may comprise: receiving, from the first apparatus, an indication to temporarily deactivating the resources allocated for sending the sequence of packets, wherein the temporarily stopping is based on the received indication.

The method may comprise: receiving, from the first apparatus, information indicating resources allocated for retransmission of one or more of the transport blocks of the first packet; and resending the one or more transport blocks corresponding to the first packet in response to receiving the information indicating the resources allocated for the retransmission.

The method may comprise receiving, from the first apparatus: a traffic pattern comprising information identifying one or more time intervals during which the second apparatus will send the sequence of packets; and/or information identifying a time period and/or a number of time intervals relating to temporarily deactivating the resources allocated for sending of the sequence of packets.

A duration of the deactivation may be based on: the one or more time intervals during which the second apparatus will send the one or more subsequent packets in the sequence; and/or the information identifying the time period and/or the number of time intervals.

The first apparatus may be a user equipment, and the second apparatus may be a network node.

The sequence of packets may comprise a sequence of video frames comprising a first frame and one or more subsequent frames.

The first frame may comprise an intra-coded picture frame, and wherein the one or more subsequent frames may comprise at least one predicted picture frame and/or at least one bidirectional predicted picture frame.

Temporarily deactivating the resources allocated for transmission of the sequence of packets may comprise: modifying resources allocated for at least one of the one or more subsequent packets for retransmission of the at least one of the one or more transport blocks corresponding to the first packet that have not been received by the second apparatus; and temporarily deactivating the remaining resources allocated for sending the sequence of packets.

According to an aspect, there is provided a computer readable medium comprising program instructions for causing an apparatus to perform at least the following: sending, to a second apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the second apparatus; and temporarily deactivating resources configured for sending the sequence of packets based on the determining.

Determining that the at least one of the one or more transport blocks corresponding to the first packet have not been successfully received by the second apparatus may comprise: receiving, from the second apparatus, an indication that the at least one of the one or more transport blocks corresponding to the first packet have not been successfully received by the second apparatus.

Temporarily deactivating the resources allocated for transmission of the sequence of packets may comprise: sending, to the second apparatus, an indication for temporarily deactivating the resources allocated for reception of the sequence of packets at the second apparatus.

Temporarily deactivating the resources allocated for transmission of the sequence of packets may comprise: cancelling transmission of any transport blocks associated with the first packet which have not been transmitted; and/or cancelling transmission of any transport blocks associated with the one or more subsequent packets; and/or cancelling transmission of any one or more higher layer packet data packets associated with the one or more subsequent packets.

The program instructions may be for causing an apparatus to perform sending, to the second apparatus: a traffic pattern comprising information identifying one or more time intervals during which the first apparatus will send the sequence of packets; and/or information identifying a time period and/or a number of time intervals relating to temporarily deactivating the resources allocated for reception of the sequence of packets at the second apparatus.

A duration of the deactivation may be based on: the one or more time intervals during which the first apparatus will send the one or more subsequent packets in the sequence; and/or the information identifying the time period and/or the number of time intervals.

The first apparatus may be a network node, and the second apparatus may be a user equipment.

The program instructions may be for causing an apparatus to perform: sending, to a third apparatus, configuration information for delivering the sequence of packets to the second apparatus via the first apparatus and the third apparatus, wherein the first apparatus is a hosting node and the third apparatus is an assisting node; and in response to determining that the at least one of the one or more transport blocks corresponding to the first packet have not been received by the second apparatus, sending, to the third apparatus, an indication for temporarily deactivating resources allocated for transmission of the sequence of packets at the third apparatus.

Determining that at least one of the one or more transport blocks corresponding to the first packet have not been received by the second apparatus may comprise: receiving, from the third apparatus, an indication that one or more transport blocks corresponding to the first packet sent via the third apparatus have not been received by the second apparatus.

The program instructions may be for causing an apparatus to perform: determining to reactivate the resources allocated for transmission of the sequence of packets; sending, to the third apparatus, an indication to reactivate the resources allocated for transmission of the sequence of packets; and sending, to the second apparatus, a command to reactivate the resources allocated for reception of the sequence of packets at the second apparatus.

The program instructions may be for causing an apparatus to perform: receiving, from a third apparatus, configuration information for delivering the sequence of packets to the second apparatus via the first apparatus and the third apparatus, wherein the first apparatus is an assisting node and the third apparatus is a hosting node, wherein the sending is performed based on the configuration information.

Determining that at least one of the one or more transport blocks corresponding to the first packet have not been received by the second apparatus may comprise: determining that the at least one of the one or more transport blocks corresponding to the first packet sent by the first apparatus have not been received by the second apparatus; and sending, to the third apparatus, an indication that the at least one of the one or more transport blocks corresponding to the first packet sent by the first apparatus have not been received by the second apparatus; or receiving, from the third apparatus, an indication that at least one of the one or more transport blocks corresponding to the first packet sent by the third apparatus have not been received by the second apparatus.

The program instructions may be for causing an apparatus to perform: receiving, from the third apparatus, an indication to reactivate the resources allocated for transmission of the sequence of packets; and sending, to the second apparatus, a command to reactivate the resources allocated for transmission of the sequence of packets.

According to an aspect, there is provided a computer readable medium comprising program instructions for causing an apparatus to perform at least the following: receiving, from a first apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the second apparatus; and temporarily stopping receiving one or more transport blocks of the sequence of packets using resources configured for reception of the sequence of packets based on the determining.

The program instructions may be for causing an apparatus to perform: sending, to the first apparatus, an indication that the at least one of the one or more transport blocks corresponding to the first packet have not been received by the second apparatus.

The program instructions may be for causing an apparatus to perform: receiving, from the first apparatus, an indication for temporarily deactivating resources allocated for reception of the sequence of packets, wherein the temporarily stopping is performed responsive to receiving the indication.

The program instructions may be for causing an apparatus to perform receiving, from the first apparatus: a traffic pattern comprising information identifying one or more time intervals during which the first apparatus will send the sequence of packets; and/or information identifying a time period and/or a number of time intervals relating to temporarily deactivating the resources allocated for reception of the sequence of packets at the second apparatus.

A duration of the deactivation may be based on: the one or more time intervals during which the first apparatus will send the one or more subsequent packets in the sequence; and/or the information identifying the time period and/or the number of time intervals.

The program instructions may be for causing an apparatus to perform: stopping decoding of at least one received transport block corresponding to the first packet in response to temporarily deactivating the resources.

The first apparatus may be a network node, and the second apparatus may be a user equipment.

According to an aspect, there is provided a computer readable medium comprising program instructions for causing an apparatus to perform at least the following: receiving, from a second apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the first apparatus; and temporarily deactivating resources configured for receiving the sequence of packets based on the determining.

Determining that at least one of the one or more transport blocks corresponding to the first packet have not been received by the second apparatus may comprise: determining that at least one of the one or more transport blocks corresponding to the first packet have not been received by the first apparatus; responsive to the determining, sending, to the second apparatus, a retransmission grant for retransmitting the at least one of the one or more transport blocks corresponding to the first packet; receiving, from the second apparatus, retransmitted one or more transport blocks corresponding to the first packet; determining that at least one of the retransmitted one or more transport blocks corresponding to the first packet have not been received by the first apparatus; and temporarily deactivating the resources in response to determining that the at least one of the retransmitted one or more transport blocks corresponding to the first packet have not been received by the first apparatus.

Temporarily deactivating the resources may comprise: sending, to the second apparatus, an indication to temporarily deactivating the resources allocated for sending the sequence of packets.

The program instructions may be for causing an apparatus to perform: stopping decoding of at least one received transport block corresponding to the first in response to temporarily deactivating the resources.

The program instructions may be for causing an apparatus to perform sending, to the second apparatus: a traffic pattern comprising information identifying one or more time intervals during which the second apparatus will send the sequence of packets; and/or information identifying a time period and/or a number of time intervals relating to temporarily deactivating the resources allocated for sending of the sequence of packets.

A duration of the deactivation may be based on: the one or more time intervals during which the second apparatus will send the one or more subsequent packets in the sequence; and/or the information identifying the time period and/or the number of time intervals.

The first apparatus may be a network node and the second apparatus may be a user equipment.

According to an aspect, there is provided a computer readable medium comprising program instructions for causing an apparatus to perform at least the following: sending, to a first apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the second apparatus; and temporarily stopping sending one or more transport blocks of the sequence of packets using resources configured for sending the sequence of packets based on the determining.

Determining that the at least one of the one or more transport blocks corresponding to the first packet have not been received by the first apparatus may comprise: receiving, from the first apparatus, an indication to temporarily deactivating the resources allocated for sending the sequence of packets, wherein the temporarily stopping is based on the received indication.

The program instructions may be for causing an apparatus to perform: receiving, from the first apparatus, information indicating resources allocated for retransmission of one or more of the transport blocks of the first packet; and resending the one or more transport blocks corresponding to the first packet in response to receiving the information indicating the resources allocated for the retransmission.

The program instructions may be for causing an apparatus to perform receiving, from the first apparatus: a traffic pattern comprising information identifying one or more time intervals during which the second apparatus will send the sequence of packets; and/or information identifying a time period and/or a number of time intervals relating to temporarily deactivating the resources allocated for sending of the sequence of packets.

A duration of the deactivation may be based on: the one or more time intervals during which the second apparatus will send the one or more subsequent packets in the sequence; and/or the information identifying the time period and/or the number of time intervals.

The first apparatus may be a user equipment, and the second apparatus may be a network node.

The sequence of packets may comprise a sequence of video frames comprising a first frame and one or more subsequent frames.

The first frame may comprise an intra-coded picture frame, and wherein the one or more subsequent frames may comprise at least one predicted picture frame and/or at least one bidirectional predicted picture frame.

Temporarily deactivating the resources allocated for transmission of the sequence of packets may comprise: modifying resources allocated for at least one of the one or more subsequent packets for retransmission of the at least one of the one or more transport blocks corresponding to the first packet that have not been received by the second apparatus; and temporarily deactivating the remaining resources allocated for sending the sequence of packets

According to an aspect, there is provided a non-transitory computer readable medium comprising program instructions for causing an apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a representation of a network system according to some example embodiments;

FIG. 2 shows a representation of a control apparatus according to some example embodiments;

FIG. 3 shows a representation of an apparatus according to some example embodiments;

FIG. 4 shows an example group of pictures organization;

FIG. 5 shows various methods according to some examples;

FIG. 6 shows an example of temporary deactivation of resources;

FIGS. 7 to 10 show signalling exchanges according to some examples; and

FIG. 11 shows an example of resource extension.

### DETAILED DESCRIPTION

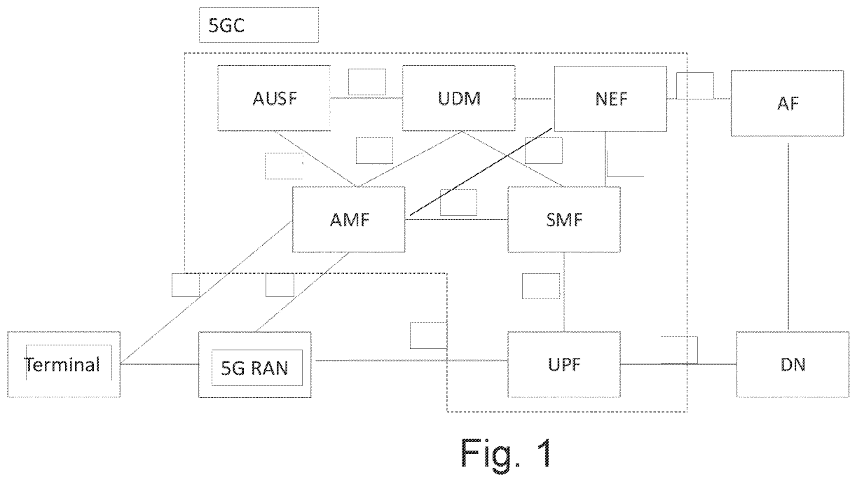

In the following certain embodiments are explained with reference to mobile communication apparatus capable of communication via a wireless cellular system and mobile communication systems serving such mobile communication apparatus. Before explaining in detail the exemplifying embodiments, certain general principles of a wireless communication system, access systems thereof, and mobile communication apparatus are briefly explained with reference to FIGS. 1, 2 and 3 to assist in understanding the technology underlying the described examples.

FIG. 1 shows a schematic representation of a 5G system (5GS). The 5GS may be comprised by a terminal or user equipment (UE), a 5G radio access network (5GRAN) or next generation radio access network (NG-RAN), a 5G core network (5GC), one or more application function (AF) and one or more data networks (DN).

The 5G-RAN may comprise one or more gNodeB (GNB) or one or more gNodeB (GNB) distributed unit functions connected to one or more gNodeB (GNB) centralized unit functions. The 5GC may comprise the following entities: Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); and Session Management Function (SMF).

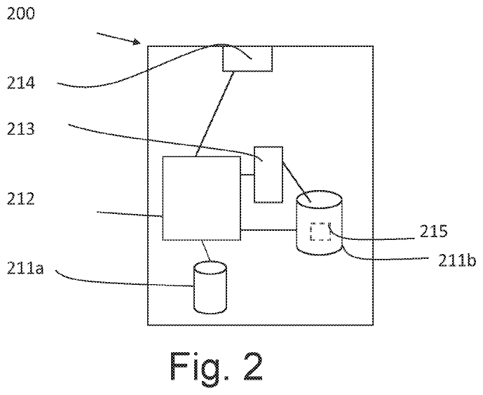

FIG. 2 illustrates an example of a control apparatus 200 for controlling a function of the 5GRAN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GC. In some embodiments, each function of the 5GRAN or the 5GC comprises a control apparatus 200. In alternative embodiments, two or more functions of the 5GRAN or the 5GC may share a control apparatus.

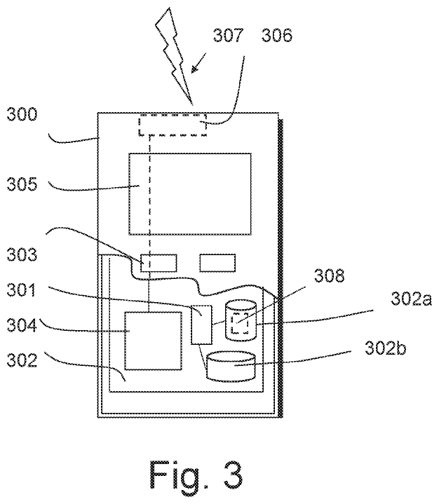

FIG. 3 illustrates an example of a terminal 300, such as the terminal illustrated on FIG. 1. The terminal 300 may be provided by any apparatus capable of sending and receiving radio signals. Non-limiting examples comprise a user equipment, a mobile station (MS) or mobile apparatus such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) apparatus, an Internet of things (loT) type communication apparatus or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile apparatus.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication apparatus. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The apparatus may optionally have a user interface such as key pad 305, touch sensitive screen or pad, combinations thereof or the like. Optionally one or more of a display, a speaker and a microphone may be provided depending on the type of the apparatus.

As described in 3GPP TR 26.928, XR refers to all real-and-virtual combined environments and associated human-machine interactions generated by computer technology and wearables. It is an umbrella term for different types of realities and typical use cases include for example augmented reality (AR), mixed reliability (MR), virtual reality (VR), cloud gaming and so on.

One important element for all XR applications is high quality video transmission. Due to the large amount of data volume for video frames, different video compression algorithms on the sequence of captured images may be adopted to reduce the size of data being transmitted.

Video compression may be achieved through a mix of intra-frame and inter-frame coding. Intra-frame coding may use lossy encoding techniques that require only the information carried in the compressed frame for decoding. In contrast, inter-frame encoding may apply differential techniques on multiple frames to encode and transmit only the differences across consecutive frames. Frames generated using intra-frame encoding may be called I-frames, while those generated using inter-frame coding may be called P-frames or B-frames, depending on the used differential technique.

Inter-frame encoding may achieve higher compression at the cost of creating dependencies across frames. To limit the long dependencies and increase reliability against transmission losses, frames may be organized into a Group of Pictures (GoP), which may comprise a sequence of consecutive frames starting with an I-frame followed by a certain number of P-frames and/or B-frames.

Thus the outcome of a video compression may be composed of up to three frame types:
I-frames (Intra-coded picture) may be generated based on a single captured image of the video stream. The achievable compression may be the lowest across the three frame types. This type of frame may not require other video frames for the decoding process.
P-frames (Predicted picture) may be generated using changes of the image with respect to the previous frame. It may achieve a higher compression ratio than I-frames but requires previous frames for the decoding.
B-frames (Bidirectional predicted picture) may use both previous and future frames as data reference for computing the changes that are encoded. B-frame may achieve the highest amount of data compression but also creates dependencies with past and future frames.

In XR applications, B-frames may be avoided to further limit dependencies across frames and speed up the decoding process at the receiver.

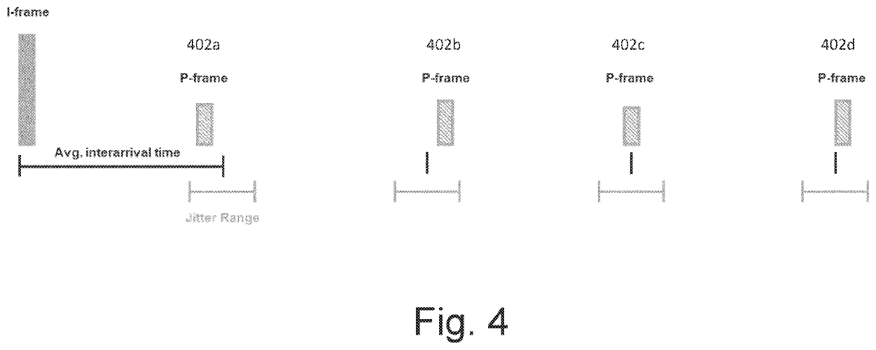

FIG. 4 shows an example of GoP organization. The example of GoP organization comprises an I-frame 400 and four subsequent P-frames 402a-d. The example of GoP organization thus creates a “bursty” traffic pattern with a large burst due to the first I-frame of the GoP followed by a sequence of smaller bursts carrying P-frames as illustrated in FIG. 4.

FIG. 4 also illustrates, for each P-frame, a jitter range. The jitter range may also be referred to as packet delay variation. The jitter range represents a range in time where the associated video frame (in the example of FIG. 4, a P-frame) is expected to arrive at the decoder when transmitted. The average inter-arrival time for each frame is also shown in FIG. 4.

3D video traffic of XR applications may show a certain deterministic periodicity. Therefore from radio resource allocation point of view, it may be beneficial to apply configured resources scheduling (such as DL semi-persistent scheduling (SPS) and/or UL configured grant (CG)) to XR traffic transmission due its lower control signaling overhead and reduced end-to-end latency. The resources can be preconfigured according to the traffic characteristics like periodicity and expected arrival time derived from the quality of service QoS profile linked to the QoS flow identifier QFI i.e. QoS characteristics and parameters.

Since P-frames carry only the difference with respect to the previous I-frame, when an I-frame is lost, all consecutive P-frames become useless since they are not self-decodable (i.e., they need the I-frame to be decoded). Hence, one potential problem with configured resource allocation (e.g. SPS and/or CG) is the waste of radio resources for the transmission of all P-frames following the loss of an I-frame. Those P-frames may not be decoded and displayed to the end user, thus the corresponding pre-configured resources are wasted.

As an example, a traffic pattern of GoP=IPPPP of FIG. 4 (i.e., four P-frames are sent after one I-frame) may be transmitted. Assuming that SPS/CG resources are configured according to this traffic pattern, then if the first I-frame is lost, then also all consecutive P-frames are lost or become useless due to the dependency on the lost I-frame. All the configured resources (before the arrival of the next I-frame) configured for P-frames transmission are wasted if no action is taken.

It should be understood that while the examples provided are in relation to an I-frame and a P-frame, the principles discussed herein may be applicable to different types of frames. In general, a first frame in a group (for example, an I-frame) may be decoded at the receiver independent of other frames in the group, while decoding of subsequent frames in the group may be dependent on a preceding frame or a future frame (for example, a P-frame or B-frame may be dependent on a preceding frame, such as an I-frame, P-frame or B-frame).

While 3GPP may specify a method of SPS/CG operation (such as activation/deactivation, configuration/release etc.), such a method may not work well for the considered scenario. For example once the SPS/CG is released, all the corresponding configurations may be released, which means a new configuration should be configured before the next I-frame. For DL SPS and Type 2 CG, frequent activation/deactivation of configured resource for delivering P-frames via PDCCH may result in an increase in overhead.

One possible way to solve the problem with the current specified SPS/CG is when I-frame is lost, gNB may de-activate the configured resource for P-frames and activates again after the next I-frame. For DL SPS and Type 2 UL CG, de-activation/activation can be done via PDCCH. For each round of operation (first de-activated, then activated again), the signalling overhead and the occupied resource for PDCCH cannot be avoided. For Type 2 UL CG, there will be additional latency as well since firstly UE should report number of needed resource, then gNB can send out PDCCH carrying de-activation command. For Type 1 UL CG, the situation is even worse since the activation/de-activation can only be done via RRC signalling, clearly signalling overhead and latency are the problems.

Some embodiments may address the problem of wasted resources for transmission of video frames following the loss of a previous video frame in a more efficient manner.

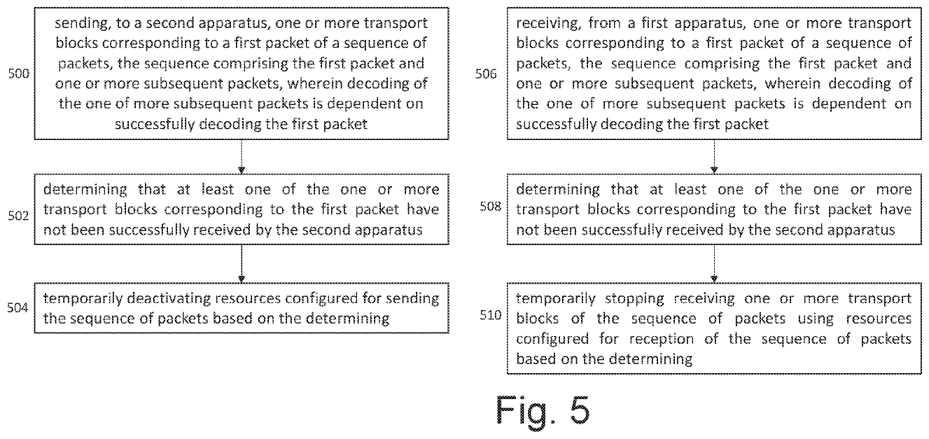

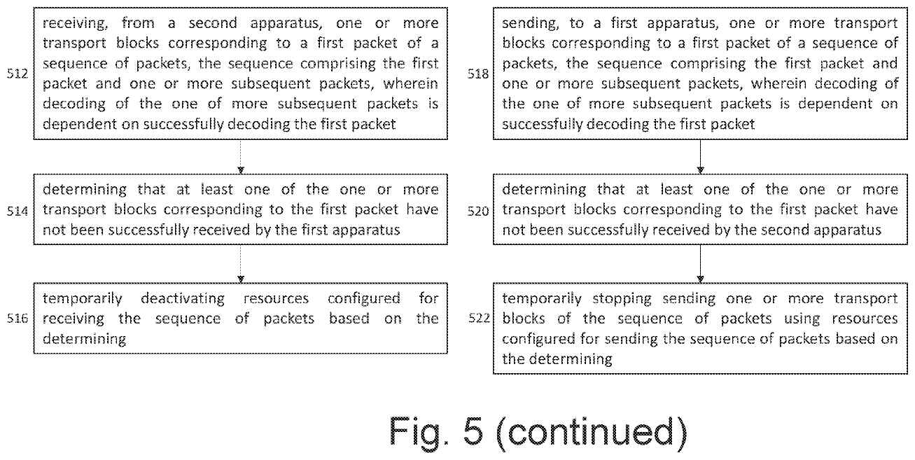

Reference is made to FIG. 5, which shows a method according to some examples.

At 500, a method may comprise sending, to a second apparatus, one or more transport blocks corresponding to a first packet of a sequence of packets, the sequence comprising the first packet and one or more subsequent packets, wherein decoding of the one of more subsequent packets is dependent on successfully decoding the first packet.

At 502, the method may comprise determining that at least one of the one or more transport blocks corresponding to the first packet have not been successfully received by the second apparatus.

At 504, the method may comprise temporarily deactivating resources configured for sending the sequence of packets based on the determining.

At 506, a method may comprise receiving, from a first apparatus, one or more transport blocks corresponding to a first packet of a sequence of packets, the sequence comprising the first packet and one or more subsequent packets, wherein decoding of the one of more subsequent packets is dependent on successfully decoding the first packet.

At 508, the method may comprise determining that at least one of the one or more transport blocks corresponding to the first packet have not been successfully received by the second apparatus.

At 510, the method may comprise temporarily stopping receiving one or more transport blocks of the sequence of packets using resources configured for reception of the sequence of packets based on the determining.

At 512, a method may comprise receiving, from a second apparatus, one or more transport blocks corresponding to a first packet of a sequence of packets, the sequence comprising the first packet and one or more subsequent packets, wherein decoding of the one of more subsequent packets is dependent on successfully decoding the first packet.

At 514, the method may comprise determining that at least one of the one or more transport blocks corresponding to the first packet have not been successfully received by the first apparatus.

At 516, the method may comprise temporarily deactivating resources configured for receiving the sequence of packets based on the determining.

At 518, a method may comprise sending, to a first apparatus, one or more transport blocks corresponding to a first packet of a sequence of packets, the sequence comprising the first packet and one or more subsequent packets, wherein decoding of the one of more subsequent packets is dependent on successfully decoding the first packet.

At 520, the method may comprise determining that at least one of the one or more transport blocks corresponding to the first packet have not been successfully received by the second apparatus.

At 522, the method may comprise temporarily stopping sending one or more transport blocks of the sequence of packets using resources configured for sending the sequence of packets based on the determining.

Thus, in some examples, a temporary de-activating SPS/CG configuration may be performed.

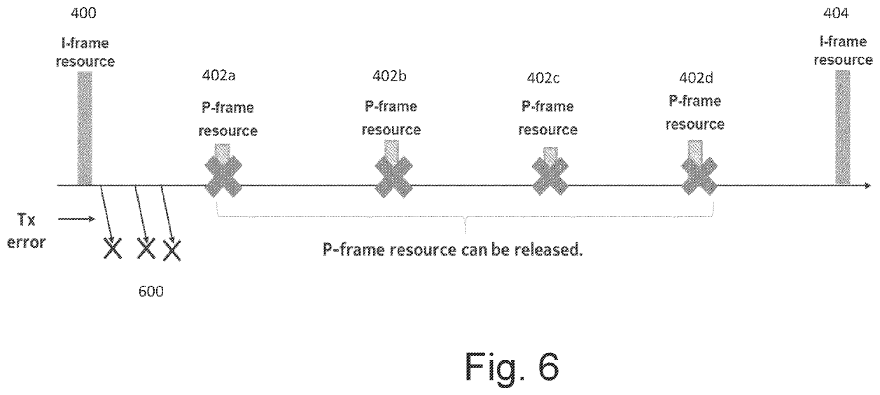

Taking the same example traffic pattern as shown in FIG. 4 previously (i.e. GoP=IPPPP) where 4 P-frames follow each I-frame. When the I-frame cannot be decoded correctly in time, the following 4 SPS/CG occasions can be temporarily deactivated as shown in FIG. 6. This may allow the resources previously allocated to the P-frames to be used for other purposes.

For example, in FIG. 6, a first I-frame 400 is transmitted in a first SPS/CG occasion, but a transmission error 600 occurs, meaning that the first I-frame 400 is not properly received and/or decoded at the receiver. The subsequent SPS/CG occasions allocated for transmission of P-frames 402a-d may thus be deactivated. However, the SPS/CG occasion corresponding to the next I-frame 404 is not deactivated, thereby allowing the second I-frame 404 to be transmitted to the receiver.

In order to support the temporary de-activation of SPS/CG configuration, a new RRC configuration may be needed in order to align transmitter (for example gNB) and receiver (for example UE) behaviour.

In some examples, a configurable timer may be provided. The transmitter (for example gNB) or the network entity (e.g. gNB) may use the timer to configure a time window which contains the temporary de-activated resources.

In some examples, a configurable number of SPS/CG occasions may be provided. The transmitter (for example gNB) or the network entity (e.g. gNB) may explicitly configure the number of temporary de-activated resources defined by the configurable number.

When the I-frame and P-frame are sent over different carriers (for example with carrier aggregation), the loss of an I-frame or one segment of an I-frame on a carrier may trigger the de-activation of the other carrier(s). The concept can be extended to cover other scenarios as well, for example I-/P-frames that are delivered over different beams/BWPs/TRPs etc.

Furthermore, in multi-connectivity scenarios, whenever the hosting node (e.g. MgNB) decides to temporarily de-activating CG/SPS resources, it may send a message to the assisting node (e.g. SgNB) for the P-frames that should be canceled. When assisting node (SgNB) receives the message, it can also temporarily de-activating SPS/CG pre-configured resources. The message may for example be a PDCP packet discarding command.

In some examples, for DL operation, SPS resources may be configured for XR traffic transmission. When a transport block (TB) with an I-frame is not able to be delivered successfully to a receiver within a packet delay budget PDB (e.g. with negative HARQ-ACK feedback after the maximum number of retransmissions), the transmitter may temporarily de-activate the next resources configured for P-frame transmission(s).

In some examples, the I-frame may be large, and segmentation may be used in radio link control, and multiple TBs may be transmitted for the same I-frame. In this case, when any of the TBs is lost, the I-frame may be considered as lost. In other words, only when all TBs are successfully received, the I-frame may be considered as successfully received as well.

In some examples, the I-frame/P-frame may be large, and segmentation may be used in radio link control, and multiple TBs may be transmitted for the same I-frame/P-frame. In this case, the cancellation of transmission may include remaining segments of the I-frame; possible segments of P-frames; and/or PDCP PDUs corresponding to the P-frames awaiting for transmission.

In some examples, the transmitter may send an explicit notification to the receiver to temporarily de-activate a certain number of subsequent SPS resources. For example, the certain number may be the following 4 SPS resources for P-frame transmission.

In other examples, the receiver may automatically deactivate SPS reception in case the I-frame data is not received correctly. For example, the receiver may deactivate the SPS resources or stopping decoding the SPS resource after sending the last NACK of I-frame to the transmitter. With this example, it is assumed that the GoP pattern is known at the receiver side (for example informed by the transmitter beforehand).

From the transmitter side, the transmitter may cancel the transmission of the following P-frames before the arrival of the next I-frame. Additionally, the receiver may stop decoding for example these 4 SPS sources (which may provide a power saving benefit at the receiver) and the transmitter can reallocate these resources for another usage (which may provide better spectral efficiency).

In some examples with sidelink communication, both the transmitter and the receiver may be UE type of devices.

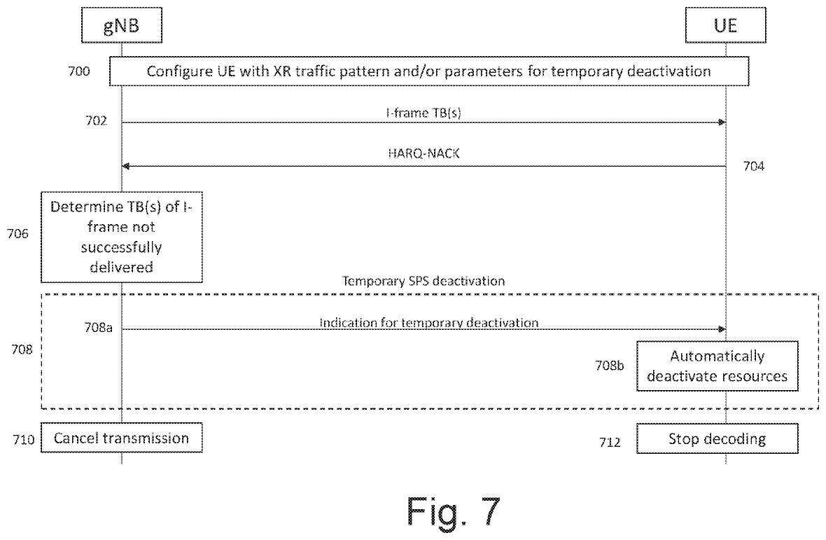

Reference is made to FIG. 7, which illustrates an example of signaling diagram for DL operation. In the example of FIG. 7, it is assumed that DL SPS resources are used for the transmission of XR traffic (e.g. video frames) from the first apparatus to the second apparatus. The first apparatus may for example be a gNB and the second apparatus may be a UE.

At 700, the first apparatus configures the second apparatus with an XR traffic pattern (for example a GoP as discussed previously) and/or parameters relating to the temporary deactivation of SPS resources (for example the timer or the number of occasions discussed previously).

At 702, the first apparatus sends at least one first frame transport block to the second apparatus using an SPS resource. The first frame may be an I-frame.

At 704, the second apparatus sends an indication to the first apparatus that at least one first frame transport block has not been properly received. The indication may for example comprise a HARQ NACK feedback.

At 706, the first apparatus determines that at least one first frame transport block was not successfully delivered to the second apparatus based on the indication received at 704.

At 708, SPS is temporarily deactivated between the first apparatus and the second apparatus.

The temporary deactivation at step 708 may comprise the first apparatus sending an indication for temporary deactivation of the SPS resource(s) to the second apparatus, as shown by step 708a in FIG. 7. Alternatively, the second apparatus may automatically deactivate SPS reception based on the information provided by the first apparatus in step 700, as shown by step 708b in FIG. 7.

At 710, the first apparatus cancels the transmission of one or more transport blocks for the first frame and one or more transport blocks for subsequent frames dependent on the first frame and one or more PDCP PDUs for subsequent frames dependent on the first frame. The subsequent frames may for example be P-frames and/or B-frames. The first apparatus may also allocate the temporarily deactivated SPS resources for other uses.

At 712, the second apparatus may stop decoding any information associated with the temporarily deactivated SPS resources. For example, the second apparatus may stop decoding the information contained in any successfully received transport blocks associated with the first frame.

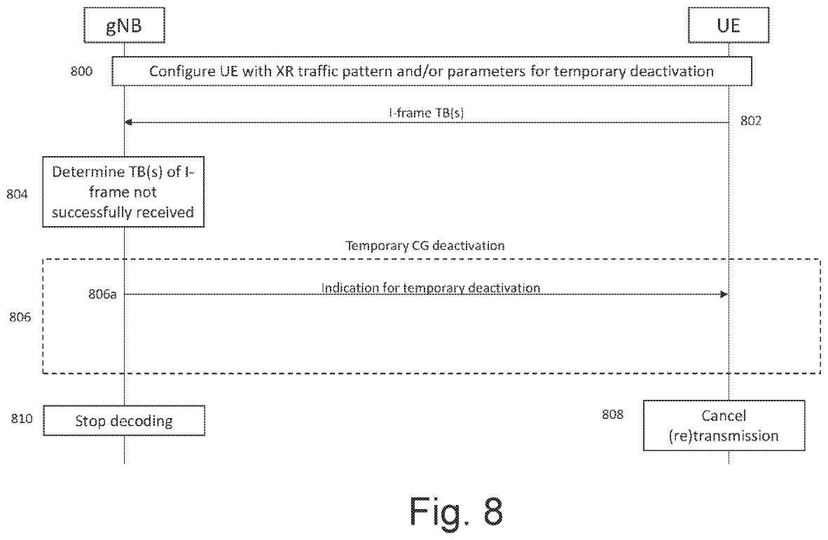

Reference is made to FIG. 8, which illustrates an example of signaling diagram for UL operation. In the example of FIG. 8, it is assumed that UL CG resources are used for the transmission of XR traffic (e.g. video frames) from the second apparatus to the first apparatus. The first apparatus may for example be a gNB and the second apparatus may be a UE.

At 800, the first apparatus configures the second apparatus with an XR traffic pattern (for example a GoP as discussed previously) and/or parameters relating to the temporary deactivation of CG resources (for example the timer or number of occasions discussed previously).

At 802, the second apparatus sends at least one first frame transport block to the first apparatus using an CG resource. The first frame may be an I-frame.

While not shown in FIG. 8, in some examples, following receipt of at least one first frame transport block at the first apparatus, the first apparatus may send a retransmission grant to the second apparatus. The second apparatus may retransmit the at least one first frame transport block to the first apparatus using the resource in response to receiving the retransmission grant.

At 804, the first apparatus determines that at least one first frame transport block has not been properly received.

At 806, CG is temporarily deactivated between the first apparatus and the second apparatus. The temporary deactivation at step 806 may comprise the first apparatus sending an indication for temporary deactivation of the CG resource(s) to the second apparatus, as shown by step 806a in FIG. 8. The indication may for example be sent via downlink control information or MAC layer signalling.

At 808, the second apparatus cancels the (re) transmission of one or more transport blocks for the first frame and one or more transport blocks for subsequent frames dependent on the first frame and one or more PDCP PDUs for subsequent frames dependent on the first frame. The subsequent frames may for example be P-frames and/or B-frames.

At 810, the first apparatus may stop decoding any information associated with the temporarily deactivated CG resources. For example, the first apparatus may stop decoding the information contained in any successfully received transport blocks associated with the first frame. The first apparatus may also allocate the temporarily deactivated CG resources for other uses. For example, the first apparatus may allocate the deactivated CG resources to other apparatus or for other traffic to the second apparatus.

In some examples, segmentation of the first frame may be implemented. When segmentation is applied, the first frame may be split among two or more transport blocks. The loss of a single segment/transport block of the first frame may result in other segments/transport blocks of the first frame useless as well.

In some examples, when at least one segment of a first frame cannot be successfully delivered within the PDB:
No HARQ (re) transmission of the other segments of the first frame is performed; and.
No HARQ (re) transmission of the segments of the following frames dependent on the first frame (e.g. P-frames) is performed;
No transmission of PDCP PDUs of the following frames dependent on the first frame (e.g. P-frames) is performed.

When carrier aggregation applied, a lost of the first frame segment on a carrier may trigger the stop of the transmission and/or re-transmissions of other ongoing segments on another carrier as well. This concept can be extended to cover other scenarios as well, for example I-/P-frames that are delivered over different beams/BWPs/TRPs etc.

In case of multi-connectivity, when the first frame cannot be delivered within the PDB by the hosting node (e.g. MgNB), in some examples, part of the next P-frames will not be forwarded over the Xn interface to the assisting node (e.g. SgNB). In this case, the hosting node may send a packet discarding message to the assisting node with an indication that will help the assisting node to cancel the corresponding SPS/CG resources. This indication can be any suitable indication, such as the (expected) number of consecutive frames that will not be forwarded or a time window indicating for how long the assisting node should not expect forwarded traffic from the hosting node.

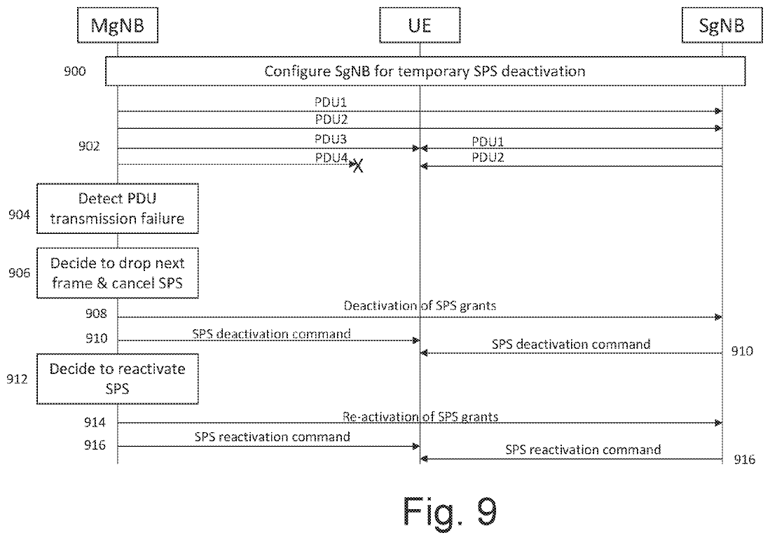

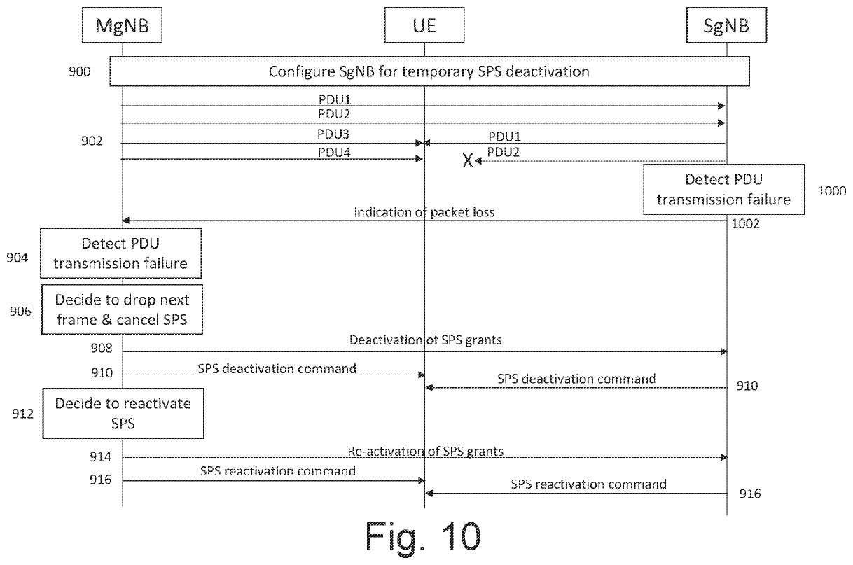

FIGS. 9 and 10 show two example procedures for temporarily deactivating and reactivating SPS grants in case with multi-connectivity.

In both FIGS. 9 and 10, the procedure starts when a secondary leg hosted by an assisting node (e.g. SgNB) is activated. As shown in step 900, the hosting node (e.g. MgNB) configures the behavior of the assisting node for temporarily deactivating and reactivating SPS grants. This may include providing one or more of: assistance information regarding the periodicity of XR traffic, the expected amount of XR traffic forwarded by the hosting node to the assisting node, and how long SPS grants should be deactivated (for example a time window to trigger a timer when SPS deactivation command sent by the hosting node is received by the assisting node).

After the configuration, at step 902, the hosting node forwards part of the traffic to the assisting node according to currently specified operations. The hosting node and assisting node then transmit PDUs to the UE.

FIG. 9 shows an example procedure where a PDU loss is detected by the hosting node.

At step 904, the hosting node detects the transmission failure of a frame caused for example by a PDU transmission failure (e.g., HARQ and/or RLC failure).

At 906, the hosting node MgNB decides to drop the next one or more frames. In this case, the hosting node deactivates the reserved SPS resources for the UE for the primary leg.

At 908, the hosting node sends an indication to the assisting node to deactivate the reserved SPS resources for the UE for the secondary leg.

Since the assisting node may not know when other XR frames/packets arrive, in some examples the hosting node may indicate to the assisting node for how long it should deactivate SPS grants, for example in the form of a time window. This time window can be communicated during the configuration phase 900. In some examples the deactivation command can contain information to increase or decrease the time window.

At 910, upon reception of the deactivation command, the assisting node will deactivate the SPS grants for the UE for the time indicated by the hosting node. For example, as shown in FIG. 9, the assisting node may send a SPS deactivation command to the UE. The hosting node may also send a SPS deactivation command to the UE.

FIG. 10 shows a similar procedure to FIG. 9, where instead of the hosting node detecting the transmission failure, at step 1000 the assisting node detects the transmission failure of a frame.

At 1002, the assisting node sends an indication of packet loss to the hosting node. In some examples, the indication may comprise one or more Sequence Numbers (SNs) of lost PDUs.

The assisting node and hosting node may then proceed as described in relation to FIG. 9.

For example, at 904, the hosting node detects the transmission error. The detection may be based on the indication received from the assisting node and decides to drop the next frame and cancel SPS reservations.

At 908, the hosting node sends an indication to the assisting node to deactivate the reserved SPS resources for the UE for the secondary leg.

At 910, the hosting node deactivates the SPS reservations for the UE on the primary leg. In some examples, the hosting node detects that the PDUs corresponding to the SNs in the received indication have caused the loss of the frame, and determines to drop transmission of one or more subsequent frames.

At 910, upon reception of the deactivation command, the assisting node will also deactivate the SPS grants for the UE for the time indicated by the hosting node.

In both of the examples shown in FIGS. 9 and 10, the hosting node may decide to reactivate SPS grants before the time window expires. This may be beneficial when, for example, a new frame arrive earlier. In this case, the hosting node informs the assisting node to reactivate the SPS grants for the secondary leg.

This is shown in FIGS. 9 and 10 by optional steps 912 to 916 for reactivating the SPS grants.

At 912, the hosting node decides to reactivate SPS grants.

At 914, the hosting node sends an indication to the assisting node to reactivate SPS resources for the UE. The indication may indicate when the assisting node should reactivate the resources.

At 916, the hosting node and the assisting node send a reactivation command to the UE for the primary leg and secondary leg respectively. It should be understood that, while FIG. 9 shows the reactivation command being sent at the same time, the reactivation command may be sent from the hosting node before, after, or at substantially the same time as the reactivation command is sent from the assisting node.

In some examples, the SPS/CG configuration assigned to a frame type may be temporarily modified, rather than deactivated.

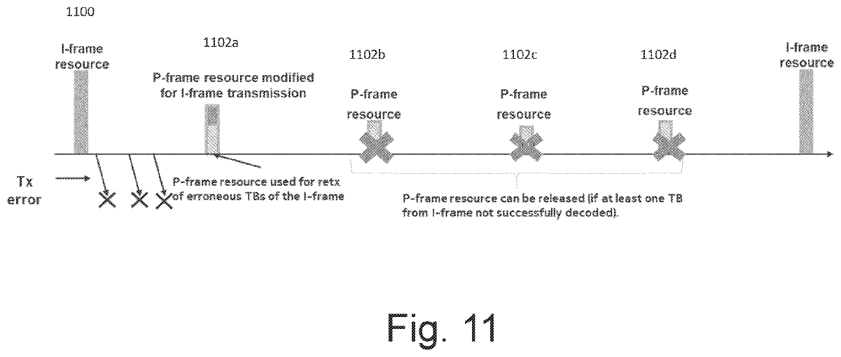

An SPS/CG originally scheduled for P-frame transmission may be increased/extended/reused to transmit one or more I-frame TBs. This may be implemented, for example, in case the P-frame resource is within the latency budget of I-frame. An example is shown in FIG. 11.

FIG. 11 shows a similar GoP configuration as in FIGS. 4 and 6—i.e. a single I-frame followed by four P-frames (GoP=IPPP). As was the case with FIG. 6, in the example of FIG. 11, one or more TBs of the initial I-frame 1100 are lost due to some form of transmission error.

In the example of FIG. 11, the resources allocated to the first P-frame 1102a after the initial I-frame 1100 may be modified. For example, resources allocated for P-frame 1102a may be extended to allow for retransmission of the one or more TBs of the initial I-frame 1100 that were lost.

In some examples, if at least one TB from the I-frame is not successfully decoded by the receiver (i.e. I-frame TB(s) from the initial I-frame 1100 or the P-frame resources or the retransmitted I-frame TB(s)) then the resources allocated for the subsequent P-frames 1102b-d may be released.

While some examples above have been presented with respect to the transmission and reception of video frames, and in particular I-frames and P-frames, it should be understood that the examples may be more generally applied to transmission and reception of a sequence of packets comprising a first packet and one or more subsequent packets, where decoding of the one or more subsequent packets is dependent on successfully decoding the first packet.

Thus, some examples may allow for transmission of a first packet to a receiver, and allow resources allocated for transmission subsequent packets dependent on the first packet to be temporarily reallocated when it is determined that at least one transport block associated with the first packet has not been received at the receiver. The reallocation may be for other uses, or may be for retransmission of the at least one transport block associated with the first packet that was not received at the receiver. As such, some examples may improve network efficiency by allowing resources that would have otherwise been wasted (due to the fact that the first packet is not properly received at the receiver, and therefore the subsequent packets dependent on the first packet may not be properly interpreted by the receiver) to be allocated for other uses.

In some examples, there is provided a first apparatus comprising means for sending, to a second apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the second apparatus; and temporarily deactivating resources configured for sending the sequence of packets based on the determining.

In some examples, the first apparatus comprises at least one processor and at least one memory including a computer program code, the at least one memory and computer program code configured to, with the at least one processor, cause the first apparatus at least to: send, to a second apparatus, one or more transport blocks corresponding to a first packet of a sequence of packets, the sequence comprising the first packet and one or more subsequent packets, wherein decoding of the one of more subsequent packets is dependent on successfully decoding the first packet; determine that at least one of the one or more transport blocks corresponding to the first packet have not been successfully received by the second apparatus; and temporarily deactivate resources configured for sending the sequence of packets based on the determining.

In some examples, there is provided a second apparatus comprising means for: receiving, from a first apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the second apparatus; and temporarily stopping receiving one or more transport blocks of the sequence of packets using resources configured for reception of the sequence of packets based on the determining.

In some examples, the second apparatus comprises at least one processor and at least one memory including a computer program code, the at least one memory and computer program code configured to, with the at least one processor, cause the second apparatus at least to: receive, from a first apparatus, one or more transport blocks corresponding to a first packet of a sequence of packets, the sequence comprising the first packet and one or more subsequent packets, wherein decoding of the one of more subsequent packets is dependent on successfully decoding the first packet; determine that at least one of the one or more transport blocks corresponding to the first packet have not been successfully received by the second apparatus; and temporarily stop receiving one or more transport blocks of the sequence of packets using resources configured for reception of the sequence of packets based on the determining.

In some examples, there is provided a first apparatus comprising means for: receiving, from a second apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the first apparatus; and temporarily deactivating resources configured for receiving the sequence of packets based on the determining.

In some examples, the first apparatus comprises at least one processor and at least one memory including a computer program code, the at least one memory and computer program code configured to, with the at least one processor, cause the first apparatus at least to: receive, from a second apparatus, one or more transport blocks corresponding to a first packet of a sequence of packets, the sequence comprising the first packet and one or more subsequent packets, wherein decoding of the one of more subsequent packets is dependent on successfully decoding the first packet; determine that at least one of the one or more transport blocks corresponding to the first packet have not been successfully received by the first apparatus; and temporarily deactivate resources configured for receiving the sequence of packets based on the determining.

In some examples, there is provided a second apparatus comprising means for: sending, to a first apparatus, one or more transport blocks corresponding to a first packet of a sequence of packets, the sequence comprising the first packet and one or more subsequent packets, wherein decoding of the one of more subsequent packets is dependent on successfully decoding the first packet; determining that at least one of the one or more transport blocks corresponding to the first packet have not been successfully received by the second apparatus; and temporarily stopping sending one or more transport blocks of the sequence of packets using resources configured for sending the sequence of packets based on the determining.

In some examples, the second apparatus comprises at least one processor and at least one memory including a computer program code, the at least one memory and computer program code configured to, with the at least one processor, cause the second apparatus at least to: send, to a first apparatus, one or more transport blocks corresponding to a first packet of a sequence of packets, the sequence comprising the first packet and one or more subsequent packets, wherein decoding of the one of more subsequent packets is dependent on successfully decoding the first packet; determine that at least one of the one or more transport blocks corresponding to the first packet have not been successfully received by the second apparatus; and temporarily stop sending one or more transport blocks of the sequence of packets using resources configured for sending the sequence of packets based on the determining.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing apparatus, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing apparatus, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile apparatus or a similar integrated circuit in server, a cellular network apparatus, or other computing or network apparatus.

The embodiments of this disclosure may be implemented by computer software executable by a data processor of the mobile apparatus, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory apparatus, magnetic memory apparatus and systems, optical memory apparatus and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1.-23. (canceled)

24. A first apparatus comprising means for:
sending, to a second apparatus, one or more transport blocks corresponding to a first packet of a sequence of packets, the sequence comprising the first packet and one or more subsequent packets, wherein decoding of the one of more subsequent packets is dependent on successfully decoding the first packet;
determining that at least one of the one or more transport blocks corresponding to the first packet have not been successfully received by the second apparatus; and
temporarily deactivating resources configured for sending the sequence of packets based on the determining.

25. The apparatus of claim 24, wherein the means is for:
sending, to a third apparatus, configuration information for delivering the sequence of packets to the second apparatus via the first apparatus and the third apparatus, wherein the first apparatus is a hosting node and the third apparatus is an assisting node; and
in response to determining that the at least one of the one or more transport blocks corresponding to the first packet have not been received by the second apparatus, sending, to the third apparatus, an indication for temporarily deactivating resources allocated for transmission of the sequence of packets at the third apparatus.

26. The apparatus of claim 24, wherein the means is for:
receiving, from a third apparatus, configuration information for delivering the sequence of packets to the second apparatus via the first apparatus and the third apparatus, wherein the first apparatus is an assisting node and the third apparatus is a hosting node,
wherein the sending is performed based on the configuration information.

27. A second apparatus comprising means for:
receiving, from a first apparatus, one or more transport blocks corresponding to a first packet of a sequence of packets, the sequence comprising the first packet and one or more subsequent packets, wherein decoding of the one of more subsequent packets is dependent on successfully decoding the first packet;
determining that at least one of the one or more transport blocks corresponding to the first packet have not been successfully received by the second apparatus; and
temporarily stopping receiving one or more transport blocks of the sequence of packets using resources configured for reception of the sequence of packets based on the determining.

28. The apparatus of claim 27, wherein the means is for:
sending, to the first apparatus, an indication that the at least one of the one or more transport blocks corresponding to the first packet have not been received by the second apparatus.

29. The apparatus of claim 27, wherein the means is for:
receiving, from the first apparatus, an indication for temporarily deactivating resources allocated for reception of the sequence of packets,
wherein the temporarily stopping is performed responsive to receiving the indication.

30. The apparatus of claim 27, wherein the means is for receiving, from the first apparatus:
a traffic pattern comprising information identifying one or more time intervals during which the first apparatus will send the sequence of packets; and/or
information identifying a time period and/or a number of time intervals relating to temporarily deactivating the resources allocated for reception of the sequence of packets at the second apparatus.

31. The apparatus of claim 30, wherein a duration of the deactivation is based on:
the one or more time intervals during which the first apparatus will send the one or more subsequent packets in the sequence; and/or
the information identifying the time period and/or the number of time intervals.

32. The apparatus of claim 27, wherein the means is for:
stopping decoding of at least one received transport block corresponding to the first packet in response to temporarily deactivating the resources.

33. A second apparatus comprising means for:
sending, to a first apparatus, one or more transport blocks corresponding to a first packet of a sequence of packets, the sequence comprising the first packet and one or more subsequent packets, wherein decoding of the one of more subsequent packets is dependent on successfully decoding the first packet;
determining that at least one of the one or more transport blocks corresponding to the first packet have not been successfully received by the second apparatus; and
temporarily stopping sending one or more transport blocks of the sequence of packets using resources configured for sending the sequence of packets based on the determining.

34. The apparatus of claim 33, wherein determining that the at least one of the one or more transport blocks corresponding to the first packet have not been received by the first apparatus comprises:
receiving, from the first apparatus, an indication to temporarily deactivating the resources allocated for sending the sequence of packets,
wherein the temporarily stopping is based on the received indication.

35. The apparatus of claim 33, wherein the means is for:
receiving, from the first apparatus, information indicating resources allocated for retransmission of one or more of the transport blocks of the first packet; and
resending the one or more transport blocks corresponding to the first packet in response to receiving the information indicating the resources allocated for the retransmission.

36. The apparatus of claim 33, wherein the means is for receiving, from the first apparatus:
a traffic pattern comprising information identifying one or more time intervals during which the second apparatus will send the sequence of packets; and/or
information identifying a time period and/or a number of time intervals relating to temporarily deactivating the resources allocated for sending of the sequence of packets.

37. The apparatus of claim 36, wherein a duration of the deactivation is based on:
the one or more time intervals during which the second apparatus will send the one or more subsequent packets in the sequence; and/or
the information identifying the time period and/or the number of time intervals.
